(19) United States
(12) Patent Application Publication
(10) Pub. No.: US 2003/0115204 A1
(43) Pub. Date: Jun. 19, 2003

(54) Structure of policy information for storage, network and data management applications

(75) Inventors: Bruce Greenblatt, San Jose, CA (US); Claudia Chandra, Emeryville, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA

(21) Appl. No.: 10/133,123

(22) Filed: Apr. 25, 2002

Related U.S. Application Data
(60) Provisional application No. 60/340,227, filed on Dec. 14, 2001.

(51) Int. Cl. G06F 15/173; G06F 7/00; G06F 17/30

(52) U.S. Cl. 707/10; 709/223; 709/224

(57) ABSTRACT

Embodiments of the present invention are directed to a system and a method for defining policies that can be used in various types of management applications for automating and performing one or more actions on at least one resource in a computer network environment. The system is configured to receive a signal indicating occurrence of a monitored event; identify rules having first conditions that are based upon the monitored event; and identify one or more rules from the rules having the first conditions for which the first conditions are satisfied. The one or more rules define one or more actions to be performed upon satisfying one or more second conditions based upon one or more non-monitored attributes of at least one resource. At least one rule is identified from the one or more rules for which the one or more second conditions of the at least one rule are also satisfied. The one or more actions to be performed for the at least one rule are defined, and are performed on the at least one resource.

The present invention is related to and claims the benefit of U.S. Provisional Patent Application No. 60/340,227, filed Dec. 14, 2001, the entire disclosure of which is incorporated herein by reference in its entirety.

### BACKGROUND OF THE INVENTION

The present invention relates to computer systems, computer networks and their use of storage systems. In particular, the present invention relates to a system and method for automating behavior in an application that manages storage systems, devices, and the data that resides on those devices, as well as the devices and interconnections in a network.

During the recent past, the use of policies in computer systems has begun to proliferate. The policies allow administrators to describe certain actions that need to happen in the case that certain conditions are satisfied. A typical example of this model is described by the Policy Common Information Model (PCIM) of the Distributed Management Task Force (DMTF). PCIM is defined in Internet RFC 3060. RFC 3060 is a publication of the Internet Engineering Task Force (IETF), and may be found at: http://www.ietf.org/rfc/rfc3060.txt?number=3060.

RFC 3060 presents an object-oriented information model for representing policy information currently under joint development in the IETF Policy Framework Working Group and as extensions to the Common Information Model (CIM) activity in the Distributed Management Task Force (DMTF). PCIM is defined as a mechanism to control activities in a computer network. One way to think of a policy-controlled network is to first model the network as a state machine and then use policy to control in which state a policy-controlled device should be or is allowed to be at any given time. A state machine is an abstract model of a computer system. In general, a state machine is any device that stores the status of information at a given time and can operate on input to change the status and/or cause an action or output to take place.

In a policy-controlled network, policies are applied using a set of policy rules. Each policy rule consists of a set of conditions and a set of actions. Policy rules may be aggregated into policy groups. These groups may be nested, to represent a hierarchy of policies. The set of conditions associated with a policy rule specifies when the policy rule is applicable. The set of conditions can be expressed as some combination of the logical operations OR and AND. Individual condition statements can also be negated. If the set of conditions associated with a policy rule evaluates to TRUE, then a set of actions that either maintain the current state of the object or transition the object to a new state may be executed.

As it turns out, the PCIM model is not entirely suitable for use in some management applications such as data, network, and storage management applications. This is due to the fact that the state machine model assumes that all conditions can be easily evaluated by the rules processing system. This is not the case in many, if not most, management applications. For example, in a storage management application, various storage volumes in the network are being administered. Each managed volume has many properties, such as the list of files on the volume. Each file has numerous properties, in addition to the properties of the volume on which it resides, and the accumulation of all of these properties are available for selection to the administrator. Some properties are more easily monitored or detected than others.

Most applications that allow for the definitions of policies use a simple “IF-THEN” structure, in which the IF clause describes a condition and the THEN clause describes the operation that the management application will perform on the objects that satisfy the condition of the IF clause. In the context of storage management, for instance, a policy may define the conditions under which a particular user can access a particular resource. This structure is often inappropriate for storage management applications as well as other management applications, because some properties or attributes on which the conditions are based are difficult to detect or infeasible to monitor.

### BRIEF SUMMARY OF THE INVENTION

Embodiments of the present invention are directed to a system and a method for defining policies that can be used in various types of management applications. These types of management applications include storage management applications, network management applications and data management applications. Policies allow administrators to define rules so that the behavior of the storage management application can be automated. The rules include conditions and associated actions which are performed upon satisfying one or more conditions. Generally two types of conditions are used. The first type of conditions are based on “monitored” events that are temporal or dynamic in that they change with time, and are referred to herein as “first” conditions. The second type of conditions are based on “non-monitored” attributes that are more static in nature, and are referred to herein as “second” conditions. In some cases, the “non-monitored” attributes do not change with time (e.g., the owner of an object or manufacturer of a device in a network) so that there is no need to monitor such attributes. In specific embodiments, the monitored events are those that are easily detectable, and “non-monitored” properties or attributes are those that are difficult or more processing intensive to detect.

In specific embodiments, the policies involve two levels of rules which are defined, respectively, for the first conditions based on monitored events and for the second conditions based on non-monitored attributes. The second conditions based on non-monitored attributes are evaluated only when one or more first conditions based on monitored events are met. One way to implement the two levels of rules is by using a When Clause and an If Clause. The When Clause describes a temporal event being monitored for evaluation of one or more first conditions. The If Clause describes attributes that are evaluated as defined by one or more second conditions, and the evaluation takes place only upon satisfying the one or more first conditions as defined in the When Clause. Thus, the attributes in the If Clause are not monitored. Actions to be performed upon satisfying the one or more second conditions of the If Clause, as well as the one or more first conditions of the When Clause, may be defined in an Action Clause.

The selection of monitored events may be based on the system constraints such as processing resource limitations in some embodiments, or may be defined by the user in other embodiments. The second conditions based on non-monitored attributes are not evaluated until one or more first conditions based on monitored events are met, thereby reducing processing time and avoiding the need to monitor events that are difficult or too processing intensive to monitor. The non-monitored attributes may be attributes of the resource(s) or object(s) being monitored, such as a storage volume in the context of storage management. Such resources or objects may be physical devices; storage locations; memory encapsulation of physical entities; data such as files and directories; device bandwidth, capacity, and performance capability; or the like. By dividing the conditions into those based on monitored events and those based on non-monitored attributes, policies can be defined and evaluated to perform actions in a more efficient and cost-effective manner. Systems and methods incorporating such dual-level policies are suitable for a variety of management applications such as storage management applications for which conventional policies would be difficult or infeasible to implement.

In accordance with an aspect of the present invention, a method of managing and automating operations to be performed in a computer network environment comprises receiving a signal indicating occurrence of a temporal event being monitored, and identifying rules having a When Clause based upon the monitored event. One or more rules are identified from the rules having the When Clause based upon the monitored event for which the When Clause evaluates to TRUE, wherein each rule in the one or more rules includes an If Clause and an Action Clause associated with the If Clause. At least one rule is identified from the one or more rules for which the If Clause of each rule in the at least one rule evaluates to TRUE.

In some embodiments, the method further comprises determining one or more actions to be performed for the at least one rule based on the Action Clause associated with each of the at least one rule. The method may comprise performing the one or more actions for the at least one rule. The one or more actions are issued to a system to be performed on one or more resources or objects for each of the at least one rule based on the Action Clause. The system may be, for instance, a server or a storage system with or without monitoring software. The objects or resource may be storage, data, network, or computer entities, files, or the like. The actions may involve management operations (e.g., data and storage management operations) to be performed in the computer network environment. Each If Clause may contain one or more conditions to be evaluated, and may identify individual objects being managed that satisfy those conditions in the computer network environment.

Another aspect of the present invention is directed to a method of automating and performing one or more actions on at least one resource in a computer network environment. The method comprises receiving a signal indicating occurrence of a monitored event; identifying rules having first conditions that are based upon the monitored event; and identifying one or more rules from the rules having the first conditions for which the first conditions are satisfied. The one or more rules define one or more actions to be performed upon satisfying one or more second conditions based upon one or more non-monitored attributes of at least one resource. At least one rule is identified from the one or more rules for which the one or more second conditions of the at least one rule are also satisfied. The method further comprises determining the one or more actions to be performed for the at least one rule, and performing the one or more actions on the at least one resource.

In some embodiments, the identified rules have different first conditions that are based upon the monitored event. At least one of the first conditions of the identified rules may be satisfied upon occurrence of the monitored event and one or more additional events. In specific embodiments, a plurality of rules are identified with the first conditions satisfied, the plurality of rules define actions to be performed upon satisfying the second conditions, and the plurality of rules have different second conditions that are based upon one or more non-monitored attributes of the at least one resource. Multiple events can be connected together using a form of logical operators as in the PCIM model. These logical operators include AND, OR and NOT, which are described in more detail below.

In accordance with another aspect of the invention, a management system of automating and managing operations to be performed in a computer network environment comprises a plurality of resources and a system. The system is configured to receive a signal indicating occurrence of a monitored event; identify rules having first conditions that are based upon the monitored event; and identify one or more rules from the rules having the first conditions for which the first conditions are satisfied. The one or more rules define one or more actions to be performed upon satisfying one or more second conditions based upon one or more non-monitored attributes of at least one resource of the plurality of resources. The server system is further configured to identify at least one rule from the one or more rules for which the one or more second conditions of the at least one rule are also satisfied; determine the one or more actions to be performed for the at least one rule; and perform the one or more actions on the at least one resource.

In some embodiments, the at least one resource comprises a storage entity. The at least one resource may comprise a network entity. The identified rules have different first conditions that are based upon the monitored event. At least one of the first conditions of the identified rules is satisfied upon occurrence of the monitored event and one or more additional events.

Another aspect of the present invention is directed to a computer program product stored on a computer readable medium for automating and performing one or more actions on at least one resource in a computer network environment. The computer program product comprises code for receiving a signal indicating occurrence of a monitored event; code for identifying rules having first conditions that are based upon the monitored event; and code for identifying one or more rules from the rules having the first conditions for which the first conditions are satisfied. The one or more rules define one or more actions to be performed upon satisfying one or more second conditions based upon one or more non-monitored attributes of at least one resource. The computer program product further comprises code for identifying at least one rule from the one or more rules for which the one or more second conditions of the at least one rule are also satisfied; code for determining the one or more actions to be performed for the at least one rule; and code for performing the one or more actions on the at least one resource.

### BRIEF DESCRIPTION OF THE DRAWINGS

FIG. 1 is a simplified block diagram of a distributed system that might incorporate an embodiment of the present invention;

FIG. 2 is a simplified block diagram of a computer system according to an embodiment of the present invention; and

FIG. 3 is a simplified high-level flowchart of a method for evaluating policies to perform actions in a management application according to an embodiment of the present invention.

### DETAILED DESCRIPTION OF THE INVENTION

Embodiments of the present invention provide a new structure for policies that can be used in various management applications. The policies involve two levels of rules which are defined, respectively, for first conditions based on monitored events that are temporal or dynamic in nature, and for second conditions based on non-monitored attributes that are more static in nature. The non-monitored attributes in some cases do not change with time so that there is no need to monitor them, or such attributes may be difficult or too processing intensive to detect or monitor. The second conditions based on non-monitored attributes are evaluated only when one or more first conditions based on monitored events are met.

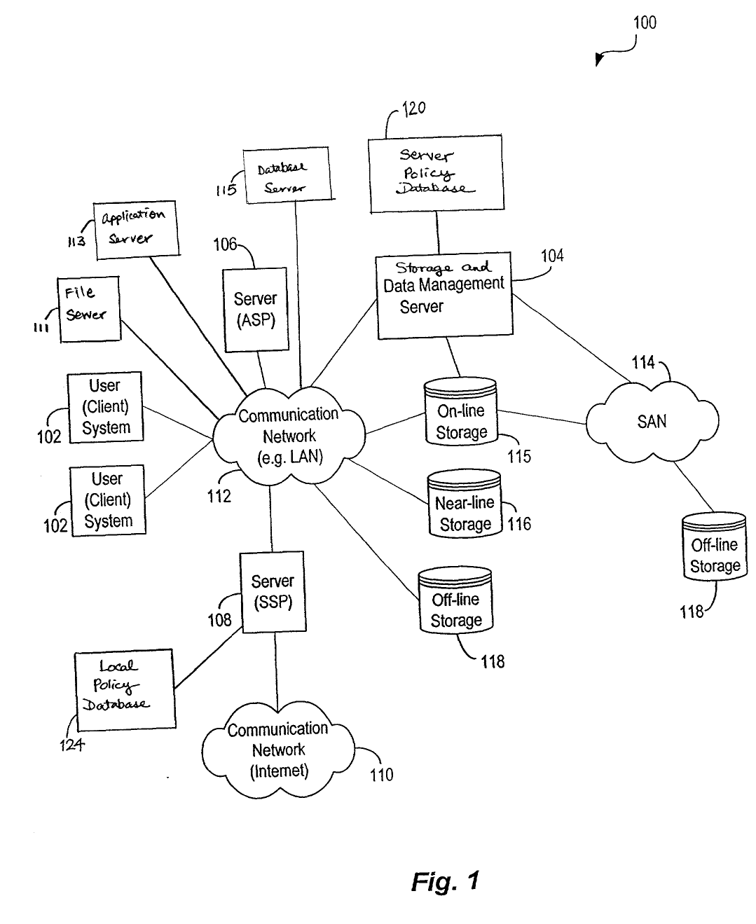

FIG. 1 is a simplified block diagram of a distributed system 100 that might incorporate an embodiment of the present invention. As depicted in FIG. 1, the distributed system 100 may comprise one or more user (client) systems 102 coupled to a communication network 112 via a plurality of communication links. The communication network 112 may be any network such as a local area network (LAN) (as shown in FIG. 1) or any other type of data communication network. A plurality of servers may be coupled to the communication network 112. These servers include a storage and data management server 104 that is configured to perform processing according to the teachings of the present invention. A server policy database 120 may be accessible to storage and data management server 104. The server policy database 120 stores server policies which enable conditions to be monitored and actions to be performed by the storage and data management server 104 based on the monitored conditions in a more efficient and cost-effective manner according to the teachings of the present invention. Other servers which may be coupled to the communication network 112 may include application service provider (ASP) servers (e.g., server 106), storage service provider (SSP) servers (e.g., server 108) which provide access to other communication networks 110 such as the Internet, and other servers. FIG. 1 also shows a file server 111, an application server 113, and a database server 115 coupled to the communication network 112. It is understood that FIG. 1 is merely illustrative and that other types of servers and devices may be included in the system 100. While the following discussion tends to focus on storage management, it is understood that the present invention is not limited to storage management but is applicable in network management, data management, and the like.

According to the teachings of the present invention, the distributed system 100 comprises one or more data storage repositories that are used to store data and information. These data storage repositories may include an on-line storage 115, a near-line storage 116, an off-line storage 118, and others. The data storage repositories may be directly coupled to the storage and data management server 104 via the communication network 112 or may alternatively be coupled to the storage and data management server 104 via other networks such as the storage area network (SAN) 114, network attached storage (NAS), and others. The distributed computer network 100 depicted in FIG. 1 is merely illustrative of an embodiment incorporating the present invention and does not limit the scope of the invention as recited in the claims. One of ordinary skill in the art would recognize other variations, modifications, and alternatives. For example, the database 120 may be directly coupled to the storage and data management server 104 as depicted in FIG. 1 or may alternatively be accessible to the storage and data management server 104 via some communication network or systems.

Computer systems connected to a distributed computer network such as the network 100 depicted in FIG. 1 can generally be classified as “clients” or “servers” depending on the roles the computer systems play with respect to requesting information or storing/providing information. Computer systems that are used by users to access information are typically referred to as “client” computers. Accordingly, the user systems 102 that may be used to access information may also be referred to as client systems.

In some embodiments, a local policy database 124 may be accessible to the individual server such as the server 108, as illustrated in FIG. 1, or to other managed servers such as application or file servers in the system 100. The local policy database 124 stores local policies which enable conditions to be monitored and actions to be performed by the server 108 based on the monitored conditions in a more efficient and cost-effective manner according to the teachings of the present invention. The database 124 may be directly coupled to the server 108 as depicted in FIG. 1 or may alternatively be accessible to the server 108 via some communication network or systems.

Computer systems which are responsible for receiving information requests from client systems, performing processing required to satisfy the requests, and for forwarding the results/information corresponding to the information requests back to the requesting client systems are usually referred to as “server” systems. The processing required to satisfy a client request may be performed by a single server system or may alternatively be delegated to other servers. It should be apparent that a particular computer system may function both as a server and a client.

The communication network 112 and other networks depicted in FIG. 1 provide a mechanism for allowing communication and exchange of information between the various computer systems and storage repositories depicted in FIG. 1. The communication networks may themselves be comprised of many interconnected computer systems and communication links. While in one embodiment, the communication network 112 is a LAN, in other embodiments, the communication network 112 may be any suitable communication network including a wide area network (WAN), a wireless network, an intranet, a private network, a public network, a switched network, and the like.

The communication links used to connect the various components depicted in FIG. 1 may be of various types. For example, the communication links may be hardwire links, optical links, satellite or other wireless communications links, wave propagation links, or any other mechanisms for communication of information. Various communication protocols may be used to facilitate communication of information via the communication links. These communication protocols may include TCP/IP, HTTP protocols, extensible markup language (XML), wireless application protocol (WAP), protocols under development by industry standard organizations, vendor-specific protocols, customized protocols, Fibre Channel protocols, and others.

As indicated above, the data storage repositories may include on-line storage, near-line storage, off-line storage, and others. The data storage repositories are generally characterized by the amount of time required to access data (referred to as “data access time” or “data seek time”) stored by the data storage repositories. The data seek time for on-line storage is generally shorter than the seek time for near-line storage. The seek time for offline storage is generally longer than the seek time for near-line storage. Off-line storage may include computer-readable storage media such as disk drives, tapes, optical devices, and the like. The data storage repositories in the specific embodiment shown in FIG. 1 are a particular type of resources that can be used in the system 100. Other types of resources include, for example, connectivity devices such as switches and routers, computer servers, and the like.

As indicated above, the storage and data management server 104 is configured to perform processing according to the teachings of the present invention. The processing may be implemented by software modules executing on the storage and data management server 104, by hardware modules coupled to the storage data management server 104, or a combination thereof. According to an embodiment of the present invention, the processing may also be performed by other computer systems and devices coupled to the storage and data management server 104.

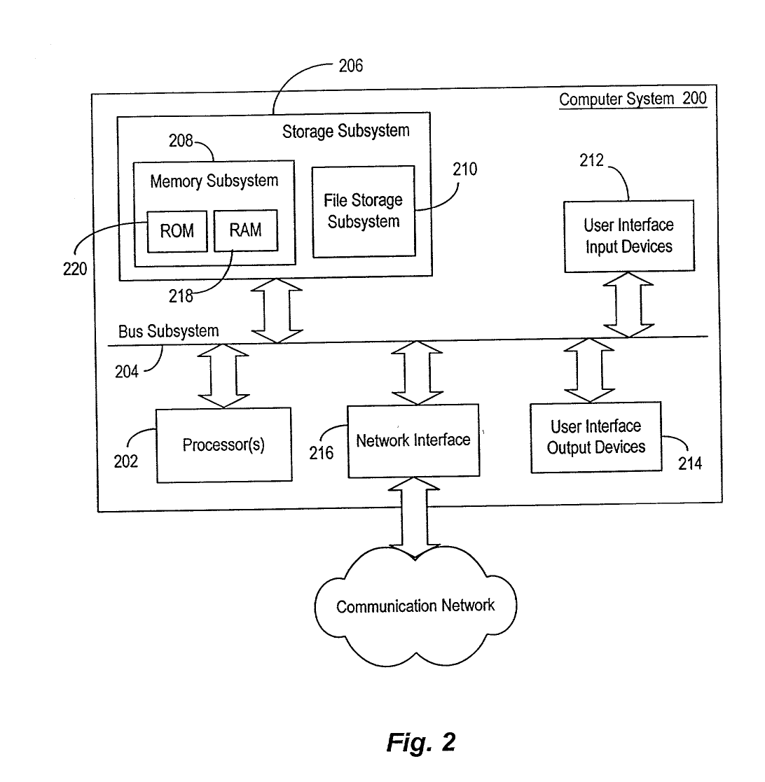

FIG. 2 is a simplified block diagram of a computer system 200 according to an embodiment of the present invention. The computer system 200 may be used as a client or a server system depicted in FIG. 1. As shown in FIG. 2, the computer system 200 includes at least one processor 202, which communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow user interaction with the computer system 200. A user may be a human user, a device, a process, another computer, and the like. The network interface subsystem 216 provides an interface to other computer systems and communication networks.

The bus subsystem 204 provides a mechanism for letting the various components and subsystems of the computer system 200 communicate with each other as intended. The various subsystems and components of the computer system 200 need not be at the same physical location but may be distributed at various locations within the network 100. Although the bus subsystem 204 is shown schematically as a single bus, alternative embodiments of the bus subsystem may utilize multiple busses.

The user interface input devices 212 may include a keyboard; pointing devices such as a Felix or optical tablet with built-in and captured puck, a mouse, a trackball, a touchpad, a graphics tablet, a scanner, a barcode scanner, a touchscreen incorporated into the display; audio input devices such as voice recognition systems, microphones; and other types of input devices. In general, use of the term “input device” is intended to include all possible types of devices and ways to input information using the computer system 200.

The user interface output devices 214 may include a display subsystem, a printer, a fax machine, or non-visual displays such as audio output devices. The display subsystem may be a cathode ray tube (CRT), a flat-panel device such as a liquid crystal display (LCD), or a projection device. The display subsystem may also provide a non-visual display, for example, via audio output devices. In general, use of the term “output device” is intended to include all possible types of devices and ways to output information from the computer system 200.

The storage subsystem 206 may be configured to store the basic programming and data constructs that provide the functionality of the computer system and of the present invention. For example, according to an embodiment of the present invention, software modules implementing the functionality of the present invention may be stored in the storage subsystem 206 of the storage and data management server 104. These software modules may be executed by processor(s) 202 of the storage and data management server 104. In a distributed environment, the software modules may be stored on a plurality of computer systems and executed by processors of the plurality of computer systems. The storage subsystem 206 may also provide a repository for storing various databases that may be used by the present invention. The storage subsystem 206 may comprise the memory subsystem 208 and the file storage subsystem 210.

The memory subsystem 208 may comprise a number of memories including a main random access memory (RAM) 218 for storage of instructions and data during program execution and a read only memory (ROM) 220 in which fixed instructions are stored. The file storage subsystem 210 provides persistent (non-volatile) storage for program and data files, and may include a hard disk drive, a floppy disk drive along with associated removable media, a Compact Digital Read Only Memory (CD-ROM) drive, an optical drive, removable media cartridges, and other like storage media. One or more of the drives may be located at remote locations on other connected computers.

The computer system 200 itself can be of varying types including a personal computer, a portable computer, a workstation, a computer terminal, a network computer, a mainframe, a kiosk, a personal digital assistant (PDA), a communication device such as a cell phone, or any other data processing system. Due to the ever-changing nature of computers and networks, the description of the computer system 200 depicted in FIG. 2 is intended only as a specific example for purposes of illustrating the preferred embodiment of the computer system. Many other configurations of a computer system are possible having more or fewer components than the computer system 200 depicted in FIG. 2.

As indicated above, the present invention provides techniques for defining policies that can be used in various types of management applications to achieve more efficient and effective management of data, storage, network, or the like. Specific embodiments of the present invention thus enable policies to be defined and evaluated to perform actions for managing data and storage in a more efficient and cost-effective manner.

According to an embodiment of the invention, each policy includes a set of rules, each of which is made up of three components:

1. When Clause—This clause describes a temporal event being monitored that has been intercepted by the management application such as the storage management application.

2. If Clause—This clause describes the conditions that are more static in nature than those in the When Clause or conditions that are too processing intensive to detect and the types of objects that should be acted upon whenever the event in the When Clause has been noticed.

3. Action Clause—This clause describes the types of operations that the storage management application will perform on the objects that satisfy the If Clause upon also satisfying the When Clause.

The structure of the When Clause and the If Clause are similar. Only events that change with time and can be detected by a management application can be mentioned in the When Clause. They are referred to herein as “temporal” events that are monitored. Multiple events can be connected together in the When Clause and/or the If Clause using a form of logical operators as in the PCIM model. These logical operators include AND, OR and NOT. The AND operator can be applied to two or more conditions. If two conditions are connected with the AND operator, then each of the conditions must be TRUE for the combination to be TRUE. If either of the conditions (or both conditions) is FALSE, then the combination is FALSE as well. The OR operator can also be applied to two or more conditions. If two conditions are connected with the OR operator, then the combination is TRUE if either of the conditions (or both conditions) is TRUE. Only if both conditions are FALSE is the combination FALSE as well. The NOT operator is applied to a single condition. The result of the NOT operator applied to a condition is TRUE when the actual condition is FALSE, and the result is FALSE when the actual condition is TRUE.

Using storage management as an example, typical events that can be detected by a storage management application are:

A file is saved or changed.

Volume usage goes above or below a certain threshold.

Storage capacity threshold is reached.

Network capacity bandwidth threshold is reached.

Certain time/schedule is satisfied or a time-related event has occurred.

The If Clause holds information about the conditions that are more static in nature than those in the When Clause and describes the kinds of objects that are acted upon. This clause describes various properties of the files. Multiple “property statements” can be joined together in the If Clause, in the same way that multiple events are joined together in the When Clause described above. Typical properties are:

The owner of the object.

The type and size of the object.

The location of the object.

Whether a user has access to a file.

Storage cost.

Device bandwidth.

Storage performance.

Data access performance requirements.

Storage capacity usage.

Last access time of files or data.

In specific embodiments, the crucial difference between the conditions in the If Clause, and those in the When Clause is as follows. Conditions in the If Clause are those that are more static in nature than those in the When Clause. In some cases, the If Clause conditions apply to the individual object and are not easily monitored by the management application. For example, in modem computer networks, access to objects is controlled through the use of Access Control Lists (ACLs). An object's ACL lists out users and named groups that have specified access to the object. A user is presumed to have access to the object by virtue of being specifically listed in the ACL, or by being a member in a named group that is listed in the ACL. As users are added and removed from groups, their access to objects changes. To make the matter more complex, groups can contain other groups as members, and users that are members of the subgroups also have access to whatever objects to which the parent groups have access. Because ACLs are not easily monitored, they are included in the If Clause rather than the When Clause.

Thus, a condition that tests whether a user can access a particular object would be part of the If Clause, and not the When Clause. The reason is that it is not feasible for the management application to continually monitor all of the groups defined in the network to see in which groups a user has membership, and then check if the user has access to any managed object. Therefore, conditions in the When Clause are those which can be relatively easily monitored by the management application. Conditions in the If Clause are those which cannot be monitored by the management application or which are difficult or too processing intensive for the management application to monitor (such as attributes of the managed object or resource), and should be detected by examining each managed object.

The Action Clause describes how the management application (e.g., storage management application) is to manipulate the object described by the If Clause. Each management application has a particular set of actions that it is able to perform. Many of these actions relate to moving data from one place in the computer network to another. Some example Rules that might be used in a storage management application (in English) are shown below.

When (a new object is created on Storage Volume A) If (the object already existed) Then (keep a backup copy of the old object on Volume B).

When (Usage of Volume A is above 90%) If (there are objects on Volume A that are owned by Users in the Sales group) Then (move these objects to Volume B).

When (Usage of Volume A is below 70%) If (there are objects on Volume B that are owned by Users in the Sales group) Then (move them to Volume A).

When (the current day is Saturday) If (there are objects on Volume A that have not been used in 7 days) Then (move the objects to Volume C).

The various volumes (A, B, C, etc.) may include, for instance, the on-line storage 115, the near-line storage 116, and the off-line storage 118 in FIG. 1.

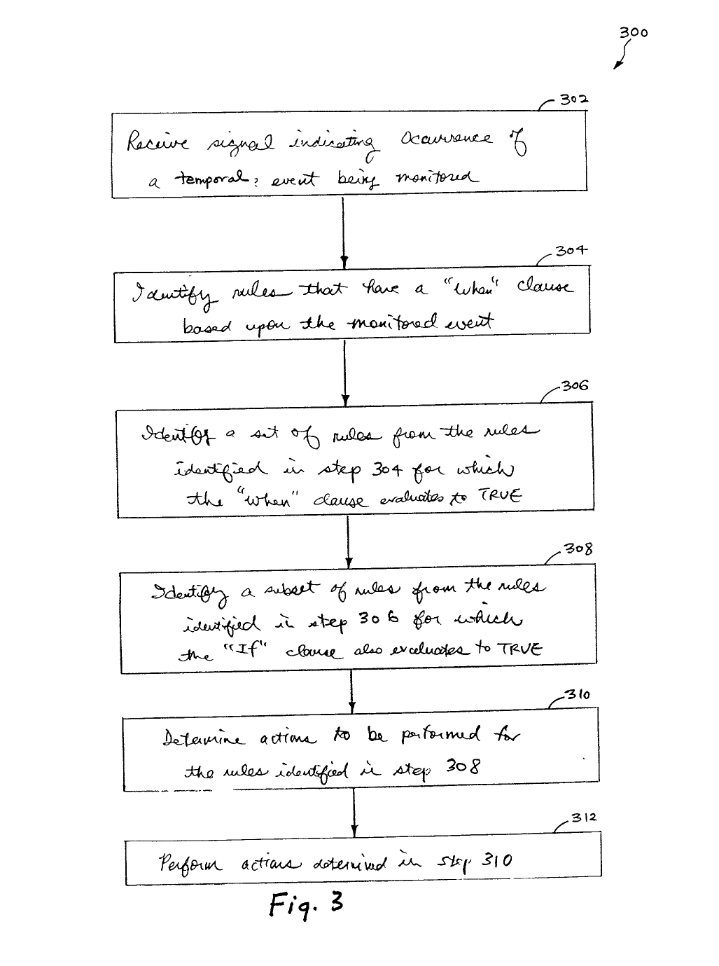

FIG. 3 is a simplified high-level flowchart 300 of a method performed by the storage and data management server 104 for defining policies which facilitate efficient monitoring of conditions and performance of actions based on the monitored conditions, according to an embodiment of the present invention. The flowchart 300 depicted in FIG. 3 is merely illustrative of an embodiment incorporating the present invention and does not limit the scope of the invention as recited in the claims. One of ordinary skill in the art would recognize other variations, modifications, and alternatives.

As depicted in FIG. 3, the storage and data management server 104 or one of the servers being managed by the storage and data management server 104 (e.g., file server 111 or database server 115) receives a signal indicating the occurrence of a “temporal” event being monitored, which can be detected by the management application (step 302). In step 304, the storage and data management server 104 identifies rules that have a “When” clause based upon the monitored event. In step 306, the storage and data management server 104 identifies a set of rules from the rules identified in step 304 for which the condition of the “When” clause is satisfied (i.e., the “When” clause evaluates to TRUE). Of the rules that satisfy the condition of the “When” clause as identified in step 306, the storage and data management server 104 identifies a subset of rules for which the condition of the “If” clause is also satisfied (i.e., the “If” clause evaluates to TRUE) (step 308). The condition of the “If” clause is based on one or more properties or attributes that are not monitored. For each of the rules that satisfy the conditions of both the “When” clause and the “If” clause as identified in step 308, the storage and data management server 104 determines the actions to be performed as defined in the “Action” clause (step 310). This may involve, for instance, determining the source and target of the action in the “Action” clause. In step 312, the actions are performed, for instance, by issuing actions to appropriate source systems.

The division of conditions into those based on monitored events and non-monitored attributes allows policies to be defined and evaluated to perform actions in a more efficient and cost-effective manner, since the conditions based on non-monitored attributes are not evaluated until one or more conditions based on monitored events are met. The use of the dual-level policies reduces processing time and avoids the need to monitor attributes that are difficult or too processing intensive to monitor. The events to be monitored can be selected based on the system constraints, wherein monitored events are easily detectable or monitored by a given system and non-monitored attributes are difficult or more processing intensive to detect by that system. How the monitored events are selected may be dictated by the processing power of the particular system, and may thus be directly correlated to the processing resources available. In alternative embodiments, a user may define what are temporal events to be monitored and what constitute non-monitored attributes. This may be done via the user interface input devices 212 in FIG. 2.

The above-described arrangements of apparatus and methods are merely illustrative of applications of the principles of this invention and many other embodiments and modifications may be made without departing from the spirit and scope of the invention as defined in the claims. For instance, although the above embodiments are described for storage management applications, the structure of policy information may be implemented for other management applications as well. The scope of the invention should, therefore, be determined not with reference to the above description, but instead should be determined with reference to the appended claims along with their full scope of equivalents.

What is claimed is:

1. A method of managing and automating operations to be performed in a computer network environment, the method comprising:
receiving a signal indicating occurrence of a temporal event being monitored;
identifying rules having a When Clause based upon the monitored event;
identifying one or more rules from the rules having the When Clause based upon the monitored event for which the When Clause evaluates to TRUE, each rule in the one or more rules including an If Clause and an Action Clause associated with the If Clause; and
identifying at least one rule from the one or more rules for which the If Clause of each rule in the at least one rule evaluates to TRUE.

2. The method of claim 1 further comprising determining one or more actions to be performed for the subset of rules based on the Action Clause associated with each of the subset of rules.

3. The method of claim 2 further comprising performing the one or more actions for the at least one rule.

4. The method of claim 3 wherein the one or more actions are issued to a system to be performed on one or more resources for each of the at least one rule based on the Action Clause.

5. The method of claim 3 wherein the actions involve storage management operations or data management operations to be performed in the computer network environment.

6. The method of claim 1 wherein each If Clause contains one or more conditions to be evaluated, the conditions applying to individual objects being managed in the computer network environment.

7. A method of automating and performing one or more actions on at least one resource in a computer network environment, the method comprising:
receiving a signal indicating occurrence of a monitored event;
identifying rules having first conditions that are based upon the monitored event;
identifying one or more rules from the rules having the first conditions for which the first conditions are satisfied, the one or more rules defining one or more actions to be performed upon satisfying one or more second conditions based upon one or more non-monitored attributes of at least one resource;
identifying at least one rule from the one or more rules for which the one or more second conditions of the at least one rule are also satisfied;
determining the one or more actions to be performed for the at least one rule; and
performing the one or more actions on the at least one resource.

8. The method of claim 7 wherein the at least one resource is selected from the group consisting of a storage entity, a data entity, a network entity, and a computer entity.

9. The method of claim 7 wherein the identified rules have different first conditions that are based upon the monitored event.

10. The method of claim 7 wherein at least one of the first conditions of the identified rules is satisfied upon occurrence of the monitored event and one or more additional events.

11. The method of claim 7 wherein a plurality of rules are identified with the first conditions satisfied, wherein the plurality of rules define actions to be performed upon satisfying the second conditions, and wherein the plurality of rules have different second conditions that are based upon one or more non-monitored attributes of the at least one resource.

12. A management system of managing and automating operations to be performed in a computer network environment, the management system comprising:
a plurality of resources; and
a system configured to:
receive a signal indicating occurrence of a monitored event;
identify rules having first conditions that are based upon the monitored event;
identify one or more rules from the rules having the first conditions for which the first conditions are satisfied, the one or more rules defining one or more actions to be performed upon satisfying one or more second conditions based upon one or more non-monitored attributes of at least one resource of the plurality of resources;
identify at least one rule from the one or more rules for which the one or more second conditions of the at least one rule are also satisfied;
determine the one or more actions to be performed for the at least one rule; and
perform the one or more actions on the at least one resource.

13. The management system of claim 12 wherein the at least one resource is selected from the group consisting of a storage entity, a data entity, a network entity, and a computer entity.

14. The management system of claim 12 wherein the identified rules have different first conditions that are based upon the monitored event.

15. The management system of claim 12 wherein at least one of the first conditions of the identified rules is satisfied upon occurrence of the monitored event and one or more additional events.

16. The management system of claim 12 wherein a plurality of rules are identified with the first conditions satisfied, wherein the plurality of rules define actions to be performed upon satisfying the second conditions, and wherein the plurality of rules have different second conditions that are based upon one or more non-monitored attributes of the at least one resource.

17. A computer program product stored on a computer readable medium for automating and performing one or more actions on at least one resource in a computer network environment, the computer program product comprising:
code for receiving a signal indicating occurrence of a monitored event;
code for identifying rules having first conditions that are based upon the monitored event;
code for identifying one or more rules from the rules having the first conditions for which the first conditions are satisfied, the one or more rules defining one or more actions to be performed upon satisfying one or more second conditions based upon one or more non-monitored attributes of at least one resource;
code for identifying at least one rule from the one or more rules for which the one or more second conditions of the at least one rule are also satisfied;
code for determining the one or more actions to be performed for the at least one rule; and
code for performing the one or more actions on the at least one resource.

18. The computer program product of claim 17 wherein the at least one resource is selected from the group consisting of a storage entity, a data entity, a network entity, and a computer entity.

19. The computer program product of claim 17 wherein the identified rules have different first conditions that are based upon the monitored event.

20. The computer program product of claim 17 wherein at least one of the first conditions of the identified rules is satisfied upon occurrence of the monitored event and one or more additional events.

21. The computer program product of claim 17 wherein a plurality of rules are identified with the first conditions satisfied, wherein the plurality of rules define actions to be performed upon satisfying the second conditions, and wherein the plurality of rules have different second conditions that are based upon one or more non-monitored attributes of the at least one resource.
